(19) United States
(12) Patent Application Publication
(10) Pub. No.: US 2010/0259805 A1
(43) Pub. Date: Oct. 14, 2010

(54) METHODS AND SYSTEMS FOR REDUCING SCANNER IMAGE DISTORTION

(75) Inventor: Yuri Vladimirovich Osipchuk, Foster City, CA (US)

Correspondence Address: Weaver Austin Villeneuve & Sampson LLP, P.O. BOX 70250, OAKLAND, CA, 94612-0250, US

(73) Assignee: MOLECULAR DEVICES, INC., Sunnyvale, CA (US)

(21) Appl. No.: 12/759,136

(22) Filed: Apr. 13, 2010

Related U.S. Application Data
(60) Provisional application No. 61/168,928, filed on Apr. 13, 2009.

(51) Int. Cl. G02B 26/10

(52) U.S. Cl. 359/197.1

(57) ABSTRACT

A scanning apparatus includes a sample stage that faces an optical scanning head or stage at a scanning plane; a first actuator that translates the sample stage or the optical stage along a first axis that is substantially parallel to the scanning plane; a sensor that senses the deviation from the first axis; and a controller coupled to the first actuator, the sensor, and the optical stage. The controller is programmed to operate the first actuator and the optical stage to acquire a scan of a sample at the sample stage; and modify the scan to compensate for a deviation from the first axis in translation of the sample stage or the optical stage along the first axis by the first actuator. Also included are methods of modifying scans to compensate for translation deviations.

### CROSS-REFERENCE TO RELATED APPLICATION

This application claims the benefit pursuant to 35 USC. §119(e) of U.S. Provisional Patent Application No. 61/168,928, filed Apr. 13, 2009, which is incorporated by reference in its entirety for all purposes.

### TECHNICAL FIELD

This invention relates to scanning of slides, and more particularly to compensating a slide scan for a scanning deviation.

### BACKGROUND

Slide scanning, e.g., of biological samples such as microarray slides, can be accomplished by translating a scanning apparatus, e.g., an optical scanning head, with respect to a slide and acquiring an image of the slide in two dimensions with the scanning apparatus. For example, a slide can be mounted in a slide holder attached to a Y-axis translation stage and an optical scan head can be attached to a translation stage on a different axis, e.g., an X-axis orthogonal to the Y-axis. The optical scanning stage can direct light, e.g., from a laser, to a sample slide, which can illuminate the sample. The optical scanning head can collect light from the sample at the slide, for example, fluorescent light emitted by fluorescently labeled DNA material that is excited by the illuminating light, and can direct the light to a detector, such as a photomultiplier tube, photodiode such as an avalanche photodiode, or the like. The signal acquired at the detector can be processed and analyzed by software, for example constructing a corresponding image based on pixel coordinates and signal intensity.

The Y-translation stage can translate in a step-wise fashion, while the line scanning apparatus can scan one line of the slide along the X-axis at each such Y-axis step. The size of the step can correspond to the Y-axis resolution of a scan, for example, 20 micrometers, 10 micrometers, 5 micrometers, or 2.5 micrometers. Combined with the scan resolution in the X-axis, the step size defines the pixel size of a scan, e.g., a scan step of 2.5 micrometers and an X-axis resolution of 2.5 micrometers corresponds to a 2.5 square micrometer pixel.

Unfortunately, deviations in translation along the axis can lead to distortion in an image developed from the scan. To reduce image distortion, it is desirable for translation along an axis to be as straight as possible. Preferably, translation along an axis deviates along the axis by a distance of less than about 2 pixels of the intended scan resolution. For example, for a scan having 2.5 square micrometer pixels as in the preceding example, deviations in translation along the Y axis would preferably be less than 5 micrometers. Such deviations can arise from characteristics of the translation stage, e.g., mechanical imperfections, which become apparent at higher scan resolutions. For example, some scanners employ cross-roller translation stages, where the stage is driven by a stepper motor actuated lead screw. Testing indicates that many cross-roller translation stages cannot meet a 2-pixel deviation standard when the step size is 2.5 micrometers. It may be possible to raise the manufacturing specifications to meet this standard, but such precision is expected to be expensive and may not be readily achievable as cross-roller translation stages are viewed as a mature technology. Higher performance translation stages, such as air bearing translation stages, are available, but are larger and much more expensive than cross-roller translation stages.

Consequently, there is a need for economical and effective apparatus and methods to address scanner image distortion associated with translation deviations from a scanning axis.

### SUMMARY

Disclosed herein are new apparatus and methods that are effective and economical in reducing or compensating for scanner image distortion caused by translation deviations from a scanning axis.

In general, the invention features a scanning apparatus that includes a sample stage that faces an optical stage at a scanning plane; a first actuator that translates the sample stage or the optical stage along a first axis that is substantially parallel to the scanning plane; and a controller coupled to the first actuator and the optical stage. The controller is programmed to operate the first actuator and the optical stage to acquire a scan of a sample at the sample stage; and modify the scan to compensate for a deviation from the first axis in translation of the sample stage or the optical stage along the first axis by the first actuator. In various embodiments, the first actuator translates the sample stage along the first axis.

The scanning apparatus includes a sensor that senses the deviation from the first axis. The sensor can be a capacitance sensor, an optical sensor, an optical encoder, a linear variable displacement transducer encoder, a laser differential interferometer, or an inductive proximity sensor. In some embodiments, the sensor is a capacitance sensor.

The controller can be programmed to determine a deviation profile according to the deviation from the first axis sensed by the sensor. The controller can also be programmed to modify the scan according to a deviation profile. The controller can also be programmed to compensate the scan for the deviation from the first axis by adapting optical data from the optical stage according to the deviation profile.

The scanning apparatus can further include a second actuator coupled to the controller that translates the sample stage or the optical stage along a second axis, wherein the second axis is nonparallel to the first axis and the second axis is substantially parallel to the scanning plane. In various embodiments, the first axis is substantially orthogonal to the second axis. In some embodiments, the second actuator translates the optical stage along the second axis. The controller can be programmed to modify the scan to compensate for a deviation from the first axis by controlling the second actuator according to the deviation profile to change the scan area.

The first actuator can be a stepper motor; a voice coil actuator; a servo motor; a linear motor; a piezoelectric actuator; a motor coupled to a crankshaft or cam; a pneumatic actuator; a motor with a lead screw; a motor with a capstan belt drive; or a motor with a chain-drive. In certain embodiments, the first actuator is a stepper motor. The first actuator can have a minimum translation resolution along the first axis of less than about 7.5, 5, 2.5, 2, 1.5, or 1 micrometers. In some embodiments, the first actuator has a minimum translation resolution along the first axis of less than about 5 micrometers, or in some embodiments, less than about 2.5 micrometers.

The second actuator can be a voice coil actuator; a stepper motor; a piezoelectric actuator; a servo motor; a linear motor; a motor coupled to a crankshaft or cam; a pneumatic actuator; a motor with a lead screw; a motor with a capstan belt drive; or a motor with a chain-drive. In certain embodiments, the second actuator is a voice coil actuator. The second actuator can have a minimum translation resolution along the second axis of less than about 7.5, 5, 2.5, 2, 1.5, or 1 micrometers. In some embodiments, the second actuator has a minimum translation resolution along the second axis of less than about 5 micrometers, or in some embodiments, less than about 2.5 micrometers.

The controller can be programmed to compensate the scan for deviation from the first axis so that after compensation, the deviation from the first axis can be less than about ±7.5, ±5, ±2.5, ±2, ±1.5, or ±1 micrometers; stated another way, the peak-peak deviation from the first axis after compensation can be less than about 15, 10, 5, 4, 3, or 2 micrometers. Typically, the controller can be programmed to compensate the scan for a deviation from the first axis so that after compensation, the deviation from the first axis is less than about ±2.5 micrometers, or in some embodiments, less than about ±1.5 micrometers.

In some embodiments, a scanning apparatus includes a sample stage that faces an optical stage at a scanning plane; a first actuator that translates the sample stage or the optical stage along a first axis that is substantially parallel to the scanning plane; and a sensor that senses the deviation from the first axis in translating the sample stage or the optical stage along the first axis, wherein the sensor is coupled to the controller.

In some embodiments, a scanning apparatus includes an optical stage at a scanning plane; a sample stage configured to oppose a sample to the optical stage at the scanning plane; a first actuator that translates the optical stage along a first axis that is substantially parallel to the scanning plane; a second actuator that translates the optical stage along a second axis, wherein the first and second axes together define a plane that is substantially parallel to the scanning plane; a sensor that senses a deviation from the first axis in translating the optical stage along the first axis; and a controller coupled to the actuators, the sensor, and the optical stage. The controller is programmed to: operate the actuators and the optical stage to acquire a scan of a sample at the sample stage; operate the sensor to create a deviation profile of the deviation from the first axis in translating the optical stage along the first axis; and compensate the scan according to the deviation profile by adapting optical data from the optical stage according to the deviation profile or controlling the second actuator according to the deviation profile.

In another aspect, the invention features scanning systems that include the new image distortion reduction mechanisms described herein, and methods of using such scanning systems. For example, such scanning systems can be scanning microscopes and microarray scanners, such as an MDS Analytical Technologies GenePix® 4000B microarray scanner, which can be used for the acquisition and analysis of expression data from DNA microarrays, protein microarrays, tissue arrays, and cell arrays.

In another aspect, the invention features methods of compensating a scan. In some embodiments, a method of compensating includes employing an optical stage to acquire a scan of a sample at a scanning plane by translating the sample or the optical stage along a first axis that is substantially parallel to the scanning plane; and compensating the scan for a deviation from the first axis in translating the sample or the optical stage along the first axis. Typically, the scan is compensated according to a deviation profile. In various embodiments, the method can include creating the deviation profile by sensing the deviation from the first axis in translating the sample stage or the optical stage along the first axis. The deviation can be sensed with a sensor as described above for the scanning apparatus.

The method can include compensating the scan by adapting optical data from the optical stage according to the deviation profile.

The method can further include translating the sample or the optical stage along a second axis, wherein the second axis is both nonparallel to the first axis and substantially parallel to the scanning plane.

The method can include compensating the scan by translating the sample or the optical stage along the second axis according to the deviation profile.

The method can include translating the sample stage along the first axis and translating the optical stage along the second axis.

The method can include translating the sample or the optical stage at a minimum translation resolution of less than about 7.5, 5, 2.5, 2, 1.5, or 1 micrometers. In some embodiments, the method includes translating the sample or the optical stage at a minimum translation resolution of less than about of less than about 5 micrometers, or in some embodiments, less than about 2.5 micrometers. The minimum translation resolutions of the sample stage and the optical stage may be the same or different.

The method can include compensating the scan for deviation from the first axis so that after compensation, the deviation from the first axis can be less than about ±7.5, ±5, ±2.5, ±2, ±1.5, or ±1 micrometers; stated another way, the peak-peak deviation from the first axis after compensation can be less than about 15, 10, 5, 4, 3, or 2 micrometers. Typically, the method can include compensating the scan for a deviation from the first axis so that after compensation, the deviation from the first axis is less than about ±2.5 micrometers, or in some embodiments, less than about ±1.5 micrometers.

A further aspect of the invention features methods of calibrating a sample holder in a scanning apparatus. In certain embodiments, a method of calibrating a sample holder involves obtaining a scanner apparatus that includes a slide holder on a sample stage; obtaining a calibration slide with a known calibration pattern comprising at least one straight longitudinal line and inserting the calibration slide into the slide holder; scanning the calibration slide to generate scan data; compensating the scan data by using information, such as distance data, from a sensor that measures the imperfections of an edge of the slide holder, such as a distance of the edge of the slide holder from the sensor, to create compensated scan data; measuring a deviation, e.g., a distance, between the straight longitudinal edge in the compensated scan data and a theoretical straight line at a plurality of points along the first axis; and generating a calibration table comprising a plurality of measures of the deviation at a plurality of point of the scan along the first axis.

The apparatuses and methods described herein are practical, economical, and effective in compensating for translation deviations in scanning, such as in microarray gene chip scanners. The apparatus and methods described herein permit compensation for translation deviations without requiring expensive high precision actuators or sample stages. Thus, scan performance can be economically and effectively improved.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIGS. 1A and 1B are perspective sketches of a scanning apparatus 100, which includes a controller 112.

FIGS. 2A and 2B are perspective sketches of a scanning apparatus 200, further including a sensor 116.

FIG. 3 is a top view of a portion of scanning apparatus 200, marked up to indicate possible sources of deviation and errors in measuring such deviations.

FIG. 4 is a perspective sketch representing scanning apparatus 300, similar to scanning apparatus 100, and further including a second actuator 118 coupled to controller 112.

FIG. 5 is a representation depicting a portion of a scanning apparatus such as scanning apparatus 200, above.

FIG. 6 is a graph that shows the output of the capacitive proximity sensor 116 versus translation along axis 110 (jagged line, labeled “A”), and an approximation of the sensor output (straight line, labeled “B”), which represents the tilt or rotation of sample stage 102.

FIG. 7 is a graph showing compensation for various deviations. Each line in FIG. 7 is corrected for angular deviation as described above for FIG. 6. Line “A” represents compensation for only the angular deviation (no compensation for deviations in translation of the sample stage or irregularities in the edge of the sample stage). Line “B” represents the data in Line “A” that is further compensated for deviations in translation of the sample stage along a first axis (no correction for irregularities in the edge of the sample stage 102). Line “C” represents the data shown in Line “A” that is further compensated for deviations in translation of sample stage along a first axis, and also for irregularities in the edge of sample stage.

FIG. 8 is a sketch depicting a top view of a calibration slide that may be used in accordance with certain embodiments.

Like reference symbols in the various drawings indicate like elements.

### DETAILED DESCRIPTION

Described herein are new mechanisms and methods that are effective and economical in reducing scanner image distortion due to translation deviations from a scanning axis. Generally, such scanners can be employed in the scanning of biological samples, for example, microscope slides and nucleic acid microarray slides. The new mechanisms and methods described herein can be used in standard slide scanning systems, such as DNA microarray or gene chip microarray scanners, to significantly reduce scanning image distortion in an effective and economical manner. For example, the new mechanisms and methods can be used in the scanning systems described in U.S. Pat. Nos. 6,555,802 and 6,628,385, which are incorporated herein by reference in their entireties.

In general, the new methods and systems avoid the added cost of high precision parts and the added effort of precise alignment of the sample slide holders that are attached to Y-translation sample stages typically used in scanners, by compensating for the non-straightness of the edge and the tilt (rotation) of standard sample holders. In these methods the profile of the holder's edge is mapped during scanner calibration procedures by using a sensor, such as a capacitive sensor, in conjunction with a test slide containing features with long straight edges in the Y-dimension and software to analyze the image and generate a correction table used to compensate later scans made using that particular sample holder. The data from the measured profile of the holder's edge is stored in the scanning instrument's memory, such as an EEPROM, and is used to compensate for the non-straightness of the holder's edge. The calibration procedure is automated and can be easily performed in the field if necessary (for example—if the slide holder needs to be replaced or repaired).

### Systems for Compensating for Scanner Image Distortion

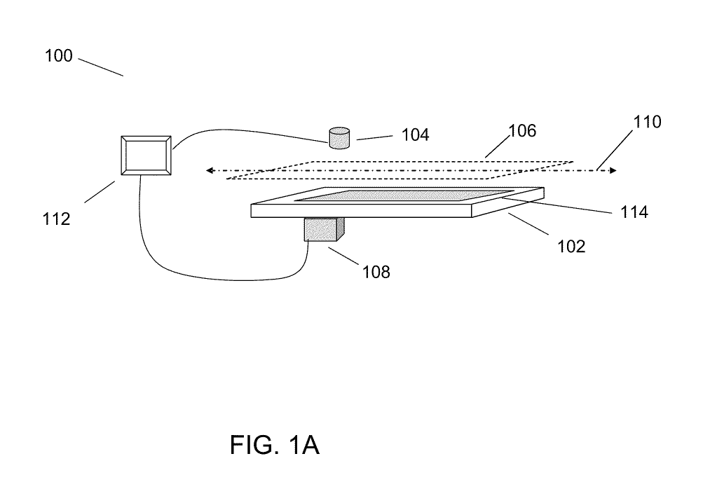

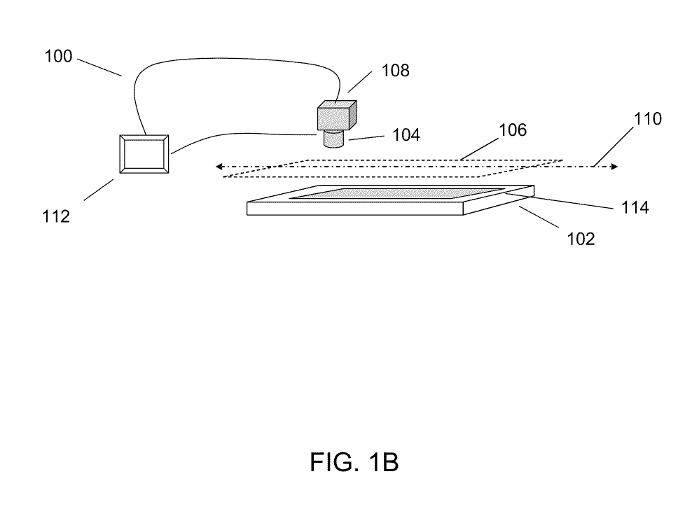

FIGS. 1A and 1B are perspective sketches of a simple scanning apparatus 100, which includes a sample stage 102 that faces a scanning head, e.g., an optical scanning head (also referred to herein as an “optical stage”) 104 at a scanning plane 106. A first actuator 108 translates along a first axis 110 that is substantially parallel to scanning plane 106. First actuator 108 can be coupled to either sample stage 102, as shown in FIG. 1A, or optical stage 104, as shown in FIG. 1B, whereby either sample stage 102 or optical stage 104 translates along first axis 110. A controller 112 can be coupled to actuator 108 and optical stage 104. Controller 112 can be programmed to operate first actuator 108 and optical stage 104 to acquire a scan of a sample 114 at sample stage 102; and compensate the scan (as described in further detail below) for a deviation from first axis 110 in translation of sample stage 102 or optical stage 104 along first axis 110 by first actuator 108.

Sample stage 102 can be, or be connected to, a slide holder configured to present a sample 114 to the scanning plane, whereby the optical stage scans the sample. The sample can be any sample of interest that is suitable for scanning in two dimensions, for example, a microscope slide or a fluorescent-tagged DNA microarray slide. Thus, in various embodiments, the scanning apparatus is a microarray scanner.

Scanning head (“optical stage”) 104 can include one or more optical scanning elements such as a mirror, a lens, a light source, a filter, a light detector, and a light pipe. A light source can be, for example, a light emitting diode, a laser such as a diode laser, a quantum dot, or a broadband source such as a xenon or halogen lamp. A light detector can be, for example, a CCD, a photomultiplier tube, or a photodiode such as an avalanche photodiode. A light pipe can include, for example, an optical fiber. A filter can include, e.g., a lowpass, bandpass, notch, or highpass filter, and can be used, for example, to filter the light source or to filter the light reflected or emitted from the sample.

For example, to examine a fluorescent sample, the sample may be illuminated with light overlapping with the excitation band of a fluorophore in the sample, causing light to be emitted from the fluorophore in a corresponding emission band. An emission filter, such as a bandpass filter corresponding to the emission band, can be employed to reject light from the sample that is outside the emission band. Similarly, an excitation filter can be employed to filter the illuminating light to a range which overlaps with the excitation band of the fluorophore, for example when using a light emitting diode or a broadband source.

In some embodiments, the optical stage 104 includes a combination of two or more of the preceding optical elements. For example, in certain embodiments, the optical stage includes a mirror and a lens.

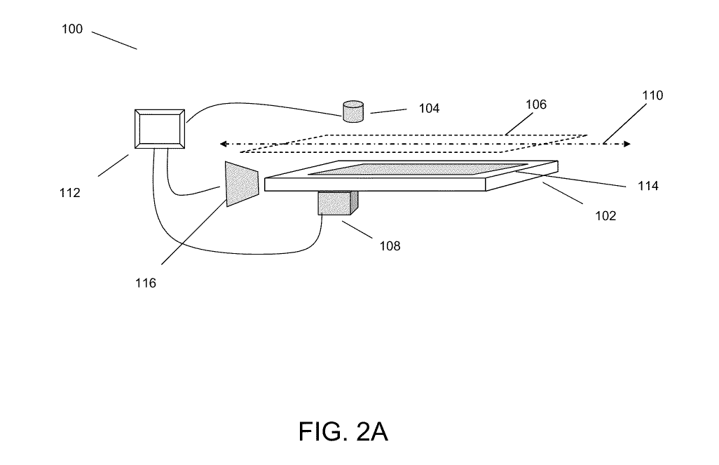

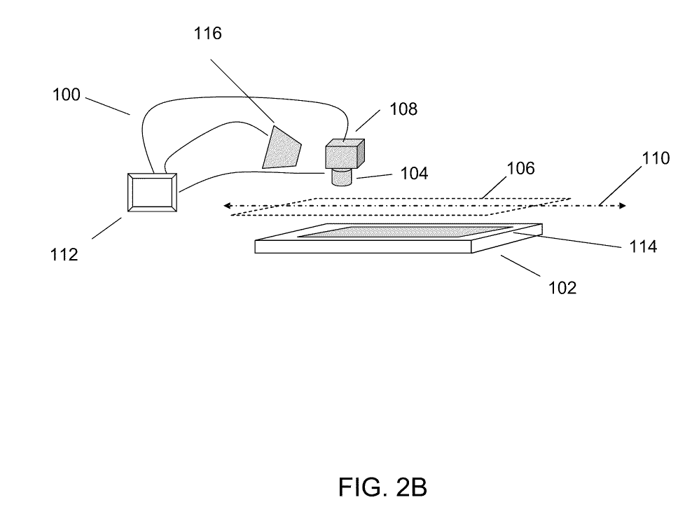

As shown in FIGS. 2A and 2B, scanning apparatus 200 includes a sensor 116 that senses deviation in translation of a stage from an axis, e.g., deviation in translation of sample stage 102 or optical stage 104 along first axis 110 by first actuator 108. FIG. 2A is a perspective sketch that shows sensor 116 configured to sense the deviation from first axis 110 when first actuator 108 is coupled to sample stage 102. FIG. 2B is a perspective sketch that shows sensor 116 configured to sense the deviation from first axis 110 when first actuator 108 is coupled to optical stage 104. Sensor 116 can be a capacitance sensor, an optical sensor, an optical encoder, a linear variable displacement transducer (LVDT) encoder, a laser differential interferometer, an inductive proximity sensor, or the like. In certain embodiments, sensor 116 is a capacitance sensor.

Controller 112 can be any suitable controller known to the art, for example, an embedded microprocessor or a programmable general purpose computer. For example, a Texas Instruments' microcontroller MSP430 can be used in various embodiments. Controller 112 is programmed to control the various stages, actuators, sensors, and the like, e.g., actuator 108, optical stage 104, and sensor 116. Controller 112 is programmed to carry out the various method steps, for example, compensating the scan according to measured deviations from the first axis. The deviations are compensated for by modifying the scan data, e.g., modifying the scan area or scan boundaries, rather than by mechanical compensation.

For this, sensor 116 measures the deviation of the stage from axis 110. The measured deviation (typically on the order of several microns, up to, for example 50 microns) is used to adjust the boundary of the scan region along the axis 120 by the measured amount. For example, if at a particular point in the scan the sensor measures a deviation of 15 microns, the controller is programmed to move the boundaries of the optical data from the scan in 120 axis by the same 15 microns, thereby compensating for the deviations.

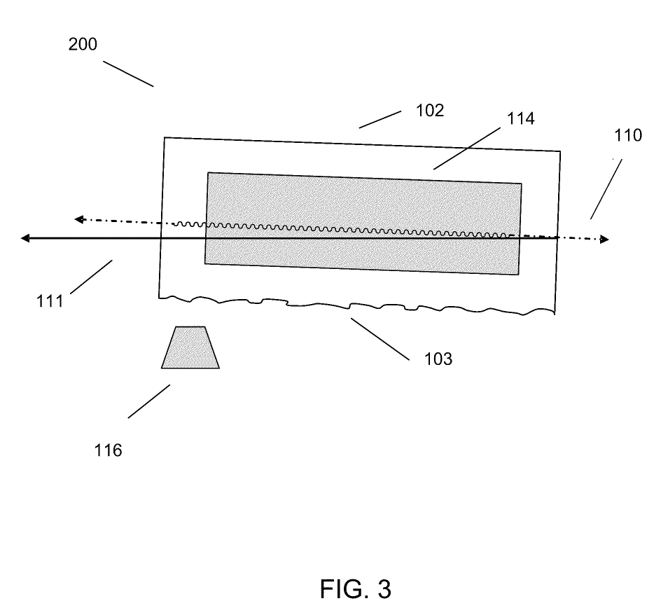

FIG. 3 is a top view of a portion of scanning apparatus 200, marked to indicate possible sources of deviation from a scanning axis 110 that are transverse or oblique with respect to first axis 110, as well as a source of error in measurements of deviation. Compared to the depiction of the scanning apparatus 100 in FIG. 2A, certain elements are omitted for clarity. One possible source of deviation arises when sensor 116 is placed to view translation along anticipated translation axis 111, but the actual direction of translation occurs along first axis 110, thus resulting in an angular deviation according to axes 110 and 111. A possible source of error in the measurement of such deviations is caused by irregularities in the edge 103 (“holder edge error”) of sample stage 102 that faces sensor 116. These irregularities can lead to apparent or virtual deviations in translational motion of sample stage 102 along first axis 110 as recorded by the data acquired by sensor 116, even if sample stage 102 translates without actual deviations along first axis 110. Yet another possible source of deviation is presented by actual deviations in translational motion of sample stage 102 along first axis 110, as indicated by the wavy line in first axis 110 (“stage (translation) error”). Thus, such deviations are transverse or oblique with respect to first axis 110. These deviations are not to scale and are presented for purposes of illustration only.

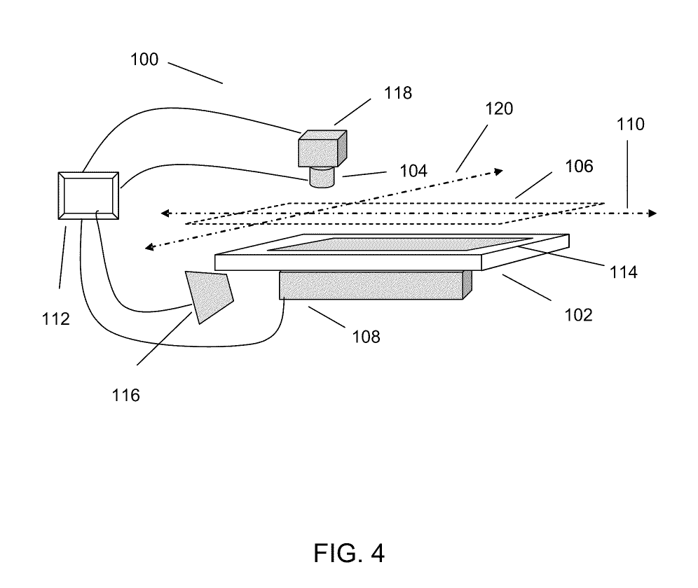

FIG. 4 is a perspective sketch representing scanning apparatus 300, similar to scanning apparatus 100, and further including a second actuator 118 coupled to controller 112. Second actuator 118 can be configured to translate the sample stage or the optical stage along a second axis, wherein the second axis is nonparallel, e.g., orthogonal, to the first axis and the second axis is substantially parallel to the scanning plane. The deviation profile is used in conjunction with the second actuator 118 to modify the scan area or scan boundaries along the axis 120 to compensate for the scan deviations. In FIG. 4, first actuator 108 is shown coupled to sample stage 102, whereby sample stage 102 translates along first axis 110, and second actuator 118 is shown coupled to optical stage 104, whereby optical stage 104 translates along second axis 120. Also in FIG. 4, second axis 120 is shown nonparallel to first axis 110 and substantially parallel to scanning plane 106.

In some embodiments, first axis 110 is substantially orthogonal to second axis 120, which is shown in perspective in FIG. 4. In various embodiments, actuators 108 and 118 can both be coupled to sample stage 102, or to optical stage 104, or actuators 108 and 118 can be coupled one each to the two stages 102 and 104. Typically, first actuator 108 will be coupled to sample stage 102, and second actuator 118 will be coupled to optical stage 104, as depicted in FIG. 4.

Actuators 108 and 118 can be any suitable actuator for use in a scanning mechanism, such as a stepper motor, a voice coil actuator, a piezoelectric actuator, a motor coupled to a crankshaft or cam, a pneumatic actuator, a motor with a lead screw, a motor with a capstan belt drive, a motor with a chain-drive; and the like. In various embodiments, first actuator 108 is a stepper motor. In various embodiments, second actuator 118 is a voice coil actuator. First actuator 108 can have a minimum translation resolution or step size along the first axis of about 7.5, 5, 2.5, 2, 1.5, or 1 micrometers. Typically, first actuator 108 has a minimum translation resolution along the first axis of about 2.5 micrometers or less. Second actuator 118 can have a minimum translation resolution along the second axis of about 7.5, 5, 2.5, 2, 1.5, or 1 micrometers. Typically, first actuator 108 has a minimum translation resolution along the first axis of about 2.5 micrometers or less.

It should be noted that sample 114 is included for the purpose of illustrating the operation of the various scanning apparatus described herein, and is thus not a required component of such scanning apparatus. Similarly, scanning plane 106, first axis 110, and second axis 120 are reference elements shown for the purpose of illustrating the operation of the various scanning apparatus described herein.

### Methods of Compensating for Scanner Image Distortion

Methods for compensating for scanner image distortion involve establishing a deviation profile for a sample slide holder and sample stage during calibration of a specific scanning apparatus. The methods also involve using the deviation profile to compensate a resulting scan made using the calibrated sample stage and sample slide holder.

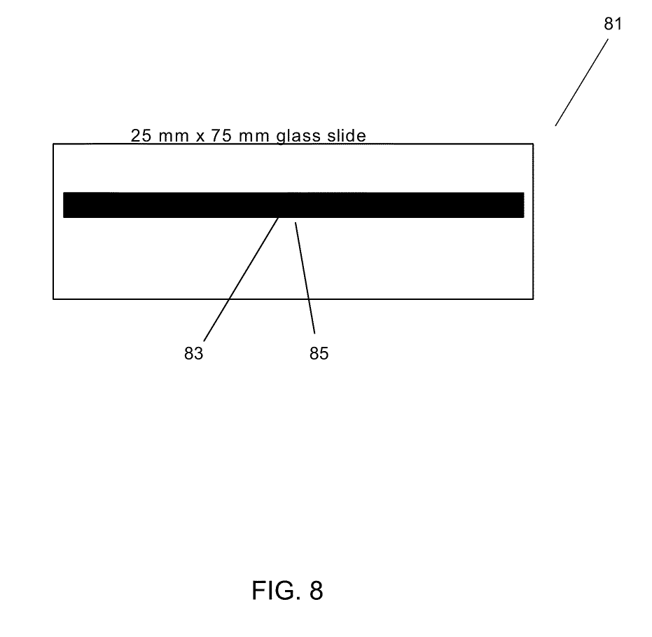

A measurement error profile is generated to correct the described deviations. A calibration slide with a known calibration pattern such as a grid is scanned and the data acquired by sensor 116 and the optical scan data collected at optical stage 104 can be examined in view of the expected calibration pattern. FIG. 8 depicts an example calibration slide 81 made using a chrome-on-glass photolithography process. The slide is 25 mm×75 mm×1 mm, with a long chrome bar 83 running along the 75 mm dimension. An edge 85 between opaque chrome and transparent glass is used for calibration. One edge is sufficient for calibration, however, slides having a pattern of a number of bars, e.g., four bars, separated by 2 mm clear glass may be used for redundancy. To use the calibration slide with fluorescence imaging, the back side of the slide is coated with a fluorescent dye. Where deviations from the expected calibration pattern are found, a measurement error profile can be constructed with instructions for corrections such as in the position or boundaries of the scanned area. Using an appropriate deviation profile for a following scan of the calibration slide, the position or boundaries of the scanned area are corrected, resulting in an image of the calibration slide according to the expected calibration pattern. For example, the error profile can also be used to correct the position or boundaries of the scanned area by controlling the scanning motion. For example, considering apparatus 100 in FIG. 4, in certain embodiments, actuator 118 can be controlled to translate optical stage 104 along second axis 120 in such a manner as to compensate for deviations which have a component in the direction of second axis 120. Note that while it is possible to change the actual translation of the optical stage 104 to compensate for the deviations, it may not be practical to do so. Accordingly, in certain embodiments, optical stage 104 stage is always translated the same way, with a little bit of “overtravel.” The data from optical stage 104 is acquired at a particular region of the travel, and the position of the sampled portion is shifted to compensate for the deviations electronically. The electronic compensation is fast and economical.

As shown in FIG. 3, during scanning sample stage 102 travels in direction 111 “in general” during a scan, but the travel is not straight. Instead, stage 102 travels along the “wavy” and non-repeatable 110 line (due to imperfections of the actuation mechanism 108, typically a cross-roller beating stage). The new systems compensate for this “waviness.” This is done by measuring the “deviation” of the stage from the straight motion and adjusting the scan position in the direction of axis 120 (shown in FIG. 4). That is, for example, if we measure at some point that the deviation from the straight line is, e.g., 5 microns along axis 120, we adjust the scan position by the same 5 micron value, negating the deviations. If the measurements of the deviation were “perfect” this would be all we would have to do to completely correct for the deviations.

However, when measuring the deviations using sensors, such as capacitive sensor 116, to measure the distance between the fixed sensor and the sample holder's edge 103, the measurements of the deviations themselves are not perfect, because the edge of the holder 103 is a machined part with regular tolerances and hence it is not straight to the required degree. When the deviation is measured at a position Y (D(Y)), it is measured with an error E(Y), so measured deviation at position Y (M(Y)) is equal to M(Y)=D(Y)+E(Y). The error E(Y) can be quite large, even larger than the deviation D(Y) itself (unless precisely lapped and expensive components are used).

Fortunately the error E(Y) is repeatable and reproducible, as it is determined only by the shape of the holder's edge 103, and the shape remains the same for each scan (unless the holder is replaced). So E(Y) needs to be measured only once, e.g., during calibration, and this function is stored in a table (Et(Y)). Thus, one can correct the measurements later on during actual scanning, thus making the deviation measurements essentially perfect. The correction factor which is applied to compensate the deviations can be referred to as C(Y). Then set C(Y)=M(Y)−Et(Y). Since M(Y)=D(Y)+E(Y), then C(Y)=D(Y)+E(Y)−Et(Y)=D(Y) if Et(Y)=E(Y). We then use corrected C(Y)=D(Y) to adjust the position of the scan, accomplishing our goal.

During the calibration we need to measure and store the Et(Y) in a table, the “measurement deviation” table. This is done as follows.

1. First one sets the Et(Y) table to zero.

2. Then one scans a calibration slide, typically with a straight edge in the Y direction, turning the compensation on (but with the Et(Y)=0 initially). The correction factor C(Y)=D(Y)+E(Y) is used to compensate the stage deviation D(Y), so the “residual”, or “virtual” deviation now is equal to D(Y)−C(Y)=−E(Y).

3. The image of the straight edge of the calibration slide is analyzed and its deviation from the “ideal” straight edge is measured as a function of Y (the measured deviation from straightness is equal to −E(Y) at this point). The measured deviation is inverted (to get rid of the minus sign) and is stored in the Et(Y) table.

4. The calibration slide is scanned again with the compensation turned on and with the newly formed Et(Y) table, to verify that the edge is now straight.

Controller 112 is programmed to compensate the scan using the Et(Y) table for deviation from the first axis so that after compensation, the deviation from the first axis is less than about ±7.5, ±5, ±2.5, ±2, ±1.5, or ±1 micrometers; stated another way, the peak-peak deviation from the first axis after compensation is less than about 15, 10, 5, 4, 3, or 2 micrometers. Controller 112 is programmed, for example, to compensate the scan for the deviation from first axis 110 by controlling second actuator 118 according to the deviation profile. Controller 112 is programmed, for example, to compensate the scan for the deviation from first axis 110 by adapting optical data from optical stage 104 according to the deviation profile. Controller 112 is also programmed, for example, to determine a deviation profile according to the deviation from first axis 110 sensed by sensor 116. The deviation profile can compensate for deviations from first axis 110 and can optionally compensate for irregularities in sample stage 102 or optical stage 104, as sensed at sensor 116.

### EXAMPLE

The following example is provided by way of illustration and is not intended to limit the invention.

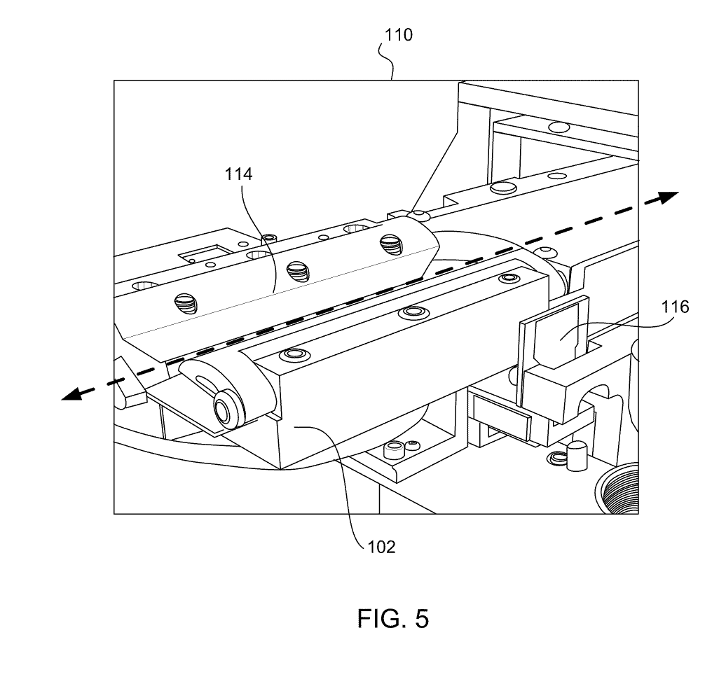

FIG. 5 is a representation of a photo of a portion of a scanning apparatus such as scanning apparatus 200 described above. FIG. 5 shows sample stage 102, which translates along a first axis 110. Sample stage 102 includes a slide holding area 114 for a sample slide. Also in FIG. 5 is sensor 116, which is shown as a capacitive proximity sensor that includes a printed circuit board with a metalized pad connected to a capacitance measurement circuit (AD7747, Analog Devices, Norwood, Mass.). Sensor 116 is positioned at a metal, electrically grounded edge of sample stage 102.

Sensor 116 is equipped to measure deviations at least in translation of sample stage 102 along first axis 110, e.g., as demonstrated in FIG. 3 by the angle between axes 110 and 111, and by the wavy portion of axis 110. Referring again to FIG. 3, if the edge 103 of sample stage 102 which faces sensor 116 deviates from a straight line by less than the desired minimum translation resolution, it may be sufficient for the deviation profile to simply account for deviations in translation of sample stage 102. However, the precision alignment and machining which may be needed to prepare edge 103 for sample stage 102 can be tedious and expensive. To avoid this additional expense, the scanning apparatus depicted in part in FIG. 5 was configured so that sensor 116 also mapped irregularities in the edge 103 (referring to FIG. 3) of sample stage 102 during a scanner calibration procedure. Using the deviation profile, the data acquired by sensor 116 and the optical scan data is corrected.

Thus, a corrected image of a calibration slide appears according to the expected calibration pattern, and a scan of a sample slide results in an improved image compared to that which would have been obtained without such correction. For example, the raw optical scan data, skewed according to an angular deviation of axis 110 (see above example between axes 110 and 111), is compensated by mathamatically transforming the raw image data to compensate for the angular deviation. Further, the deviation profile includes a baseline adjustment for data acquired at sensor 116 based on the mapped irregularities in the edge 103 of sample stage 102 from the scanner calibration procedure. Consequently, the deviation profile described in this Example can compensate for both deviations in translation of sample stage 102 along first axis 110 and irregularities in the edge 103 of sample stage 102.

This has the added benefit of permitting replacement of sample stages 102, since the different irregularities in edge 103 of the replacement sample stage can be compensated for by simply performing another scanner calibration procedure.

During a scanning calibration procedure, a test slide having registration lines was inserted into sample stage 102 so that the registration lines aligned with first axis 110. The test slide was scanned to detect the registration lines from which deviations were determined and recorded. At the same time, the capacitance sensor readings were detected and recorded. Through software analysis, the capacitance sensor map of the edge 103 of sample stage 102 was correlated with an optical scan of the registration lines on the test slide to generate a baseline correction table or deviation profile. For use in correcting future scans, the deviation profile was then stored in the controller of the scanning apparatus. The calibration procedure is automated and can be easily performed in the field if necessary, for example, if the slide holder needs to be replaced or repaired.

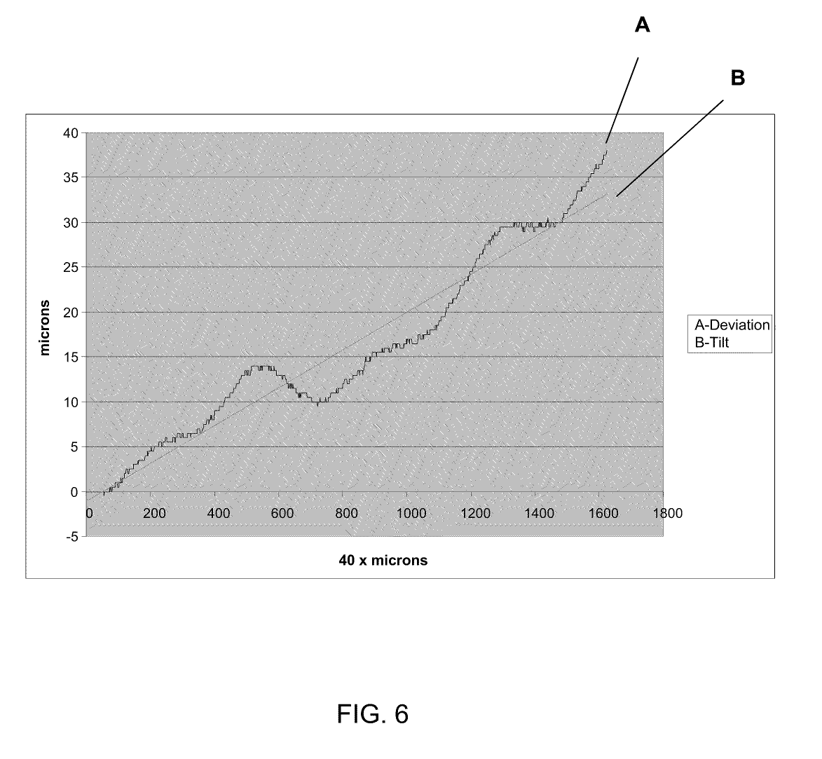

FIG. 6 is a graph that shows the output of the capacitive proximity sensor 116 versus translation along axis 110 (jagged line, labeled “A”), and an approximation of the sensor output (straight line, labeled “B”), which represents the angular deviation of sample stage 102. This angular deviation corresponds to the angle shown between axes 110 and 111 in FIG. 3. The values of the angular deviation were stored and were then subtracted from the capacitive sensor's output values during compensation. This allows independent compensation of the angular deviation.

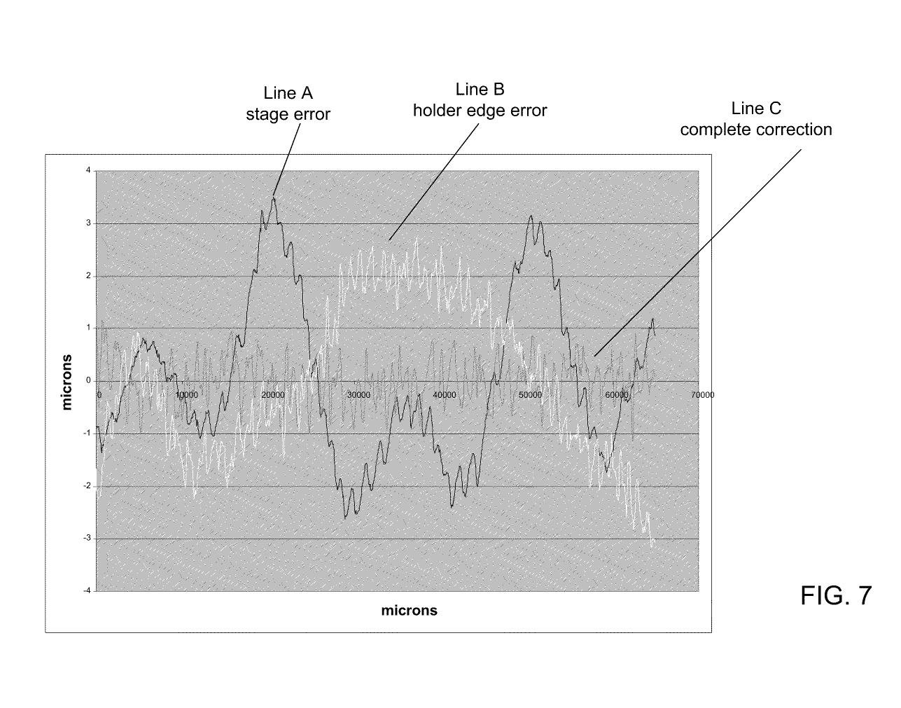

FIG. 7 is a graph showing compensation for various deviations as measured using capacitive sensor 116 and the test slide. Each line in FIG. 7 is corrected for angular deviation as described above for FIG. 6. In FIG. 7, Line “A” represents deviations from a straight line of the image of a straight edge of the test slide, obtained by image analysis of the test slide's image compensation for only the angular deviation. Line “A” does not include compensation for either deviations in translation of sample stage 102 or irregularities in edge 103 of sample stage 102 that faces sensor 116, the compensations are turned off. The measured deviation from the straight line is larger than 6 micrometers peak-to-peak.

Line “B” represents another scan of the test slide, showing deviations from a straight line in the image of the test slide with compensation turned on, but with Et(Y) table containing zeroes. In essence the line “B” is the data shown in Line “A” which is further compensated for deviations in translation of sample stage 102 along first axis 110, e.g., as illustrated in FIG. 3 by the wavy line in axis 110. Line “B” does not include correction for irregularities in edge 103 of sample stage 102. The line “B” represents the Et(Y) data, which is then stored in the EPROM.

Line “C” represents another scan of the test slide, showing deviations from a straight line in the image of the test slide with compensation turned on and adjusted to include Et(Y) table containing data obtained during scan “B”. In essence the line “C” is the data shown in Line “A” which is further compensated for deviations in translation of sample stage 102 along first axis 110, e.g., as illustrated in FIG. 3 by the wavy line in axis 110, and also for irregularities in edge 103 of sample stage 102 by applying the compensation from the Et(Y) table.

Preferably, translation along an axis deviates along the axis by a distance of less than about 2 pixels of the intended scan resolution. For example, for a scan having square 2.5 micrometer pixels, deviations in translation along first axis 110 would preferably be less than 5 micrometers. Since the residual deviations shown by Line “C” are less than 2.5 micrometers peak to peak, the apparatus of this example is suited for correction of scans having a minimum translation resolution or pixel size of 1.25 micrometers.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A scanning apparatus, comprising:
a sample stage that faces an optical scanning head at a scanning plane;
a first actuator that translates the sample stage or the optical scanning head along a first axis that is substantially parallel to the scanning plane;
a proximity sensor that senses a deviation from the first axis; and
a controller coupled to the first actuator, the sensor, and the optical scanning head, wherein the controller is programmed to
operate the first actuator and the optical scanning head to acquire a scan of a sample on the sample stage; and
modify the scan to compensate for a deviation from the first axis in translation of the sample stage or the optical scanning head, or both, along the first axis by the first actuator.

2. The scanning apparatus of claim 1, wherein the sensor is a capacitance sensor, an optical sensor, an optical encoder, a linear variable displacement transducer encoder, a laser differential interferometer, or an inductive proximity sensor.

3. The scanning apparatus of claim 2, wherein the sensor is a capacitance sensor.

4. The scanning apparatus of claim 1, further comprising a second actuator coupled to the controller that translates the sample stage or the optical scanning head along a second axis, wherein the second axis is nonparallel to the first axis and the second axis is substantially parallel to the scanning plane.

5. The scanning apparatus of claim 4, wherein the first actuator translates the sample stage along the first axis.

6. The scanning apparatus of claim 4, further comprising an optical stage and wherein the second actuator translates the optical stage along the second axis.

7. The scanning apparatus of claim 6, wherein the first axis is substantially orthogonal to the second axis.

8. The scanning apparatus of claim 1, wherein the first actuator is a stepper motor; a voice coil actuator; a piezoelectric actuator; a motor coupled to a crankshaft or cam; a pneumatic actuator; a motor with a lead screw; a motor with a capstan belt drive; or a motor with a chain-drive.

9. The scanning apparatus of claim 1, wherein the first actuator is a stepper motor.

10. The scanning apparatus of claim 1, wherein the first actuator has a minimum translation resolution along the first axis of less than about 5 micrometers.

11. The scanning apparatus of claim 1, wherein the first actuator has a minimum translation resolution along the first axis of less than about 2.5 micrometers.

12. The scanning apparatus of claim 4, wherein the second actuator is a voice coil actuator; a stepper motor; a piezoelectric actuator; a motor coupled to a crankshaft or cam; a pneumatic actuator; a motor with a lead screw; a motor with a capstan belt drive; or a motor with a chain-drive.

13. The scanning apparatus of claim 4, wherein the second actuator is a voice coil actuator.

14. The scanning apparatus of claim 4, wherein the second actuator has a minimum translation resolution along the second axis of less than about 5 micrometers.

15. The scanning apparatus of claim 4, wherein the second actuator has a minimum translation resolution along the second axis of less than about 2.5 micrometers.

16. The scanning apparatus of claim 1, wherein the controller is programmed to compensate the scan for a deviation from the first axis so that after compensation, the deviation from the first axis is less than about ±2.5 micrometers.

17. The scanning apparatus of claim 2, wherein the controller is programmed to determine a deviation profile according to the deviation from the first axis sensed by the sensor.

18. The scanning apparatus of claim 1, wherein the controller is programmed to modify the scan according to a deviation profile.

19. The scanning apparatus of claim 5, wherein the controller is programmed to modify the scan to compensate for the deviation from the first axis by adapting optical data from the optical scanning head according to the deviation profile.

20. The scanning apparatus of claim 7, wherein the controller is programmed to modify the scan to compensate for the deviation from the first axis by controlling the second actuator according to the deviation profile.

21. A biological scanning apparatus, comprising:
a sample stage that faces an optical scanning head at a scanning plane;
a first actuator that translates the sample stage or the optical scanning head along a first axis that is substantially parallel to the scanning plane; and
a sensor that senses a deviation from the first axis in translating the sample stage or the optical scanning head along the first axis.

22. (canceled)

23. A method of calibrating a sample holder in a scanning apparatus, the method comprising:
obtaining a scanner apparatus that includes a slide holder on a sample stage;
obtaining a calibration slide with a known calibration pattern comprising at least one straight longitudinal line and inserting the calibration slide into the slide holder;
scanning the calibration slide to generate scan data;
compensating the scan data by using information, such as distance data, from a sensor that measures the imperfections of an edge of the slide holder, such as a distance of the edge of the slide holder from the sensor, to create compensated scan data;
measuring a deviation, e.g., a distance, between the straight longitudinal edge in the compensated scan data and a theoretical straight line at a plurality of points along the first axis; and
generating a calibration table comprising a plurality of measures of the deviation at a plurality of point of the scan along the first axis.

24. (canceled)

25. A method of compensating a scan, the method comprising:
employing an optical scanning head to acquire scan data of a sample at a scanning plane by translating the sample or the optical scanning head along a first axis that is substantially parallel to the scanning plane; and
modifying the scan data according to a deviation profile that describes a deviation from the first axis in translating the sample or the optical scanning head along the first axis.

26-35. (canceled)
